(19) United States
(12) Patent Application Publication
(10) Pub. No.: US 2004/0231137 A1
(43) Pub. Date: Nov. 25, 2004

(54) Method of manufacturing local coils using pre-tuned non-magnetic circuitry modules

(76) Inventor: Derek Seeber, Wauwatosa, WI (US)

Correspondence Address: QUARLES & BRADY LLP, 411 E. WISCONSIN AVENUE, SUITE 2040, MILWAUKEE, WI, 53202-4497, US

(21) Appl. No.: 10/441,709

(22) Filed: May 20, 2003

(51) Int. Cl. H01P 11/00; H01Q 13/00; H01R 43/00; H01F 27/06

(52) U.S. Cl. 29/601; 29/600; 29/602.1; 29/854; 336/65; 336/221; 336/90

(57) ABSTRACT

Manufacturing of local coils for magnetic resonance imaging systems operating to receive and transmit signals may be simply constructed by applying selected pre-manufactured, modular, multi-component circuits to antenna conductors of the coil.

### STATEMENT REGARDING FEDERALLY SPONSORED RESEARCH OR DEVELOPMENT

--

### CROSS-REFERENCE TO RELATED APPLICATIONS

--

### BACKGROUND OF THE INVENTION

The present invention relates generally to local coils for use in magnetic resonance imaging (MRI) systems and in particular to a manufacturing technique for such coils.

Magnetic resonance imaging is used to generate medical diagnostic images by measuring faint radio frequency signals (magnetic resonance) emitted by atomic nuclei in tissue (for example, protons) after radio frequency stimulation of the tissue in the presence of a strong magnetic field.

The radio frequency stimulation may be applied, and the resulting magnetic resonance signal detected, using a “local coil” having a resonant antenna structure tuned to a narrow band, for example, 64 MHz for 1.5 Tesla field strength magnetic fields. The local coil is adapted to be placed near or on the patient to decrease the effects of external electrical noise on the detected magnetic signal.

One manufacturing technique for such local coils constructs the resonant antenna structure out of thin copper strips attached to an insulating support. This structure may be fabricated using printed circuit board material in which the strips are etched from copper cladding on such material.

The coil is completed by the addition of other discrete components such as capacitors, inductors and, diodes which tune the coil and which provide matching networks, phase splitters, phase combiners, switches, bias control, and decoupling of the local coil depending on the design. These components are typically soldered directly to the copper strips during construction of the coil, prior to encasing the coil in a housing. The capacitors are typically chip capacitors which do not have leads such as are normally a magnetic material that would be incompatible with use in an MRI machine. Similarly, the inductors are air core or plastic core inductors eliminating magnetic ferrites or the like.

Many of the circuits created with these discrete components are “frequency sensitive”, a result of the complex impedances of their constituent inductors and capacitances, and must be “tuned” to provide particular characteristics, such as input impendence or phase shift, for the particular frequency of operation of the coil. Such tuning is normally performed on a unit-by-unit basis as part of the manufacturing of the coil after the components are attached to the copper strips. Specialized MRI local coils are normally manufactured in relatively low volumes.

### SUMMARY OF THE INVENTION

The present inventors have recognized that a limited set of standard circuits may be practically pre-manufactured in modular form for use in the assembly of a wide variety of MRI coils. The modules may use a non-magnetic package with standardized terminals and may be pre-tuned, so that the modules can be quickly installed on a coil. Pre-tuning simplifies the tuning process because it can be done in isolation of the coil and because it can be done for a large number of modules in one session using specialized jigs and dedicated equipment. Low volume applications that would normally not be amenable to pre-manufactured modules, possibly because a wide range of characteristics are required, can be accommodated using a set of pre-tuned modules of predetermined denominations that may be combined to produce any of the range of values.

Specifically then, the present invention provides a method of manufacturing local coils for use in a magnetic resonance imaging system comprising the steps of assembling a plurality of multi-component circuits, each on a substantially non-magnetic carrier having exposed terminals communicating with the multi-component circuits. The electrical parameters of the multi-component circuits are pre-characterized to conform to defined electrical parameters. An antenna structure of a local coil is then assembled using antenna conductors supported on at least one insulating support and terminals of at least one of the carriers containing one of the multi-component circuits are attached to the conductors of the antenna structured to complete the local coil. The multi-component circuits may include phase shift networks, quad divider combiner networks, bias T networks, radio frequency switch networks, isolation networks and matching networks.

Thus, it is one object of the invention to provide simplified manufacture of local coils by eliminating components normally assembled on the coils in favor of pre-assembled and pre-tuned standardized modules.

The circuits may be constructed of substantially non-magnetic components including, for example, air core inductors and chip capacitors, on a substantially non-magnetic carrier.

Thus it is another object of the invention to provide the benefits of modular pre-manufactured components in a high magnet field strength environment of MRI.

The pre-characterization may include a step of tuning the adjustable components in the multi-component circuit.

Thus it is another object of the invention to provide for efficiencies of scale in the tuning operation required for these modular circuits.

The pre-characterization may in addition or alternatively include the step of testing the multi-component circuits for confirmation with the defined electrical parameters.

It is yet another object of the invention to provide for efficiencies of scale in testing the circuits and to simplify the testing of the circuits which can be done prior to attachment to the coil.

The electrical parameters may be those of input impedance and output impedance at a given operating frequency.

Thus it is an object of the invention to provide modules with good energy transfer characteristics.

The multi-component circuits may be phase shift networks and the step of assembling a plurality of multi-component circuits may include the manufacture of a plurality of phase shift circuits of different standard values of phase shift and step of assembling the coil may include the step of connecting at least two of the phase shift circuits in series to obtain a desired phase shift being a sum of standard values.

Thus it is another object of the invention to pre-manufacture circuits that would normally require tuning in order to obtain the desired range of values.

The carrier may be a printed circuit board having an insulating substrate and copper traces.

It is another object of the invention to provide a simple non-magnetic substrate for use in this application.

The carrier may have terminals extending from the bottom of the carrier.

Thus it is another object of the invention to provide a module allowing simple connection to typical antenna conductors.

The terminals may be plate-through holes connecting to pads on the bottom surface of the carrier.

It is another object of the invention to provide a terminal structure readily manufacturable using standard printed circuit board techniques.

The manufacturing may include the step of attaching a non-magnetic housing to the carrier to cover the multi-component circuit.

It is yet another object of the invention to provide standard modules that are encapsulated to resist alteration, damage, and contamination.

These particular objects and advantages may apply to only some embodiments falling within the claims and thus do not define the scope of the invention.

### BRIEF DESCRIPTION OF THE FIGURES

FIG. 1 is a simplified perspective view of an MRI machine showing an example local coil for use with that MRI machine;

FIG. 2 is an exploded fragmentary perspective view of conductors of the local coil of FIG. 1 forming an antenna structure supported on an insulating substrate and connected to two phase shifting modules of the present invention for obtaining a pre-determined phase shift between the antenna structure and an external pre-amplifier;

FIG. 3 is a cross-sectional view of one module of FIG. 2 taken along the line 3-3 showing attachment of an air core inductor and capacitor chip to traces running on the upper surface of a standard printed circuit board communicating with terminals on the lower surface of the printed circuit board through plate-through holes and having a hermetic non-magnetic covering attached thereto;

FIG. 4 is a perspective fragmentary view of the plate-through hole of FIG. 3 showing a cutting of the printed circuit board at the plate-through holes for improved mass production of the modules;

FIG. 5 is an electrical schematic of a first multi-component circuit beneficially manufactured using the present invention for phase shifting; and

FIG. 6 is an electrical schematic of a second multi-component circuit suitable for use with the present invention for applying a bias current to a coil;

### DETAILED DESCRIPTION OF THE PREFERRED EMBODIMENT

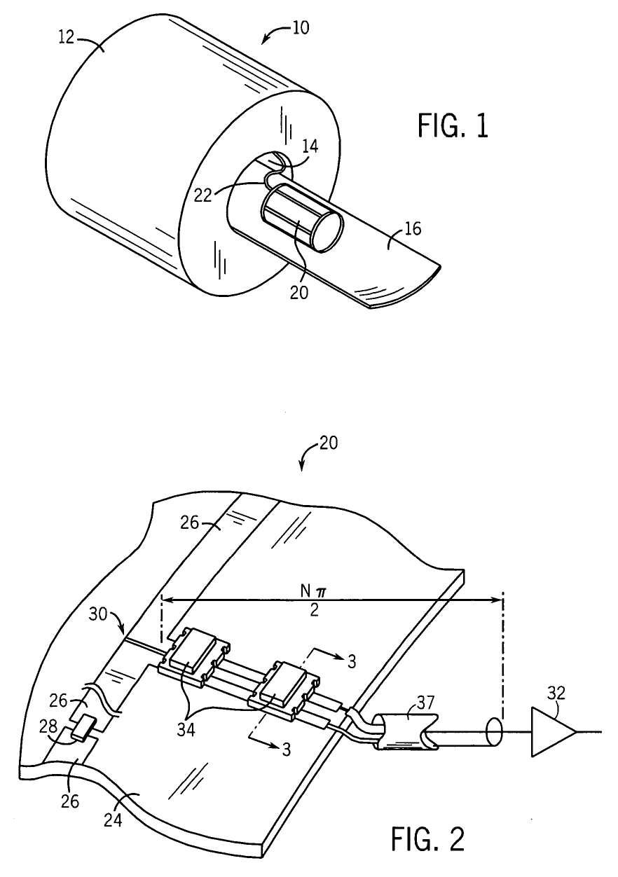

Referring now to FIG. 1, an example magnetic resonance imaging machine 10 includes a polarizing magnet 12, for example, having a field strength of 1.5 Tesla. The polarizing magnet 12 may have a bore 14 receiving a patient table 16 on which a patient (not shown) and a local coil 20 may be supported to be received within the bore 14 for scanning. The local coil 20 typically includes a cable 22 for connecting the local coil 20 to amplifiers within the MRI machine 10. The cable 22 conducts a radio frequency excitation signal from the MRI machine 10 to the local coil for a transmit local coil 20 and conducts an NMR signal from the local coil 20 to the MRI machine 10 for a received local coil 20. The local coil 20 depicted is a head coil, however, the present invention may work with a variety of local coils of different designs for different regions of the body and having both transmit and/or receive capabilities.

Referring now to FIG. 2, the local coil may provide insulating support 24 conforming to a portion of the patient anatomy on which antenna conductors 26 may be attached. The antenna conductors 26 typically are in the form of one or more loops for receiving the NMR signal or to transmitting the excitation signal from and to a volume of interest. Each loop of the antenna conductors 26 may be broken by one or more capacitors 28 soldered to the surface of the antenna conductors 26 to provide for a resonant electrical structure of the type well known in the art.

A tap 30 may be formed in each loop of the antenna conductors 26 so as to allow a portion of the signal running through the loop to be conducted via signal lead 37 to an external amplifier 32. The external amplifier 32 may be a high input impedance amplifier and be placed an electrical distance from the tap 30 that is an odd multiple of _{π}/2 to provide a low tap impedance.

The physical distance between the tap 30 and the amplifier 32 may not match this desired electrical distance of an odd multiple of _{π}/2 and so one or more phase shift network modules 34 may be inserted between the tap 30 and the amplifier 32. The value of phase shift provided by the modules 34 is selected so that together with inherent phase shift of the connecting signal lead 37 and connections between the tap point 30 and the modules 34, the necessary total phase shift is obtained.

For this purpose, each of the modules 34 may desirably contain a pre-tuned phase shift circuit having a fixed denomination of phase shift. For example, for a given frequency of operation (e.g., 64 MHz) phase shift modules 34 may be created with the values of 1, 2, 3, 4, 5, 6, 7, 8, 9 and 10 degrees of phase shift and also for the values of 10, 20, 30, 40, 50, 60, 70 and, 80 degrees of phase shift. Accordingly, series connection of no more than two phase shift modules 34 may be used create any phase shift from zero to ninety degrees phase shift in one-degree increments.

In this way, an arbitrary degree of phase shifting may be obtained without in-place tuning of the modules. Further the modules 34 may be used with a wide variety of present and future designs of local coils 20 making them cost-effective for even local coils 20 with low manufacturing volumes or subject to frequent changes in design.

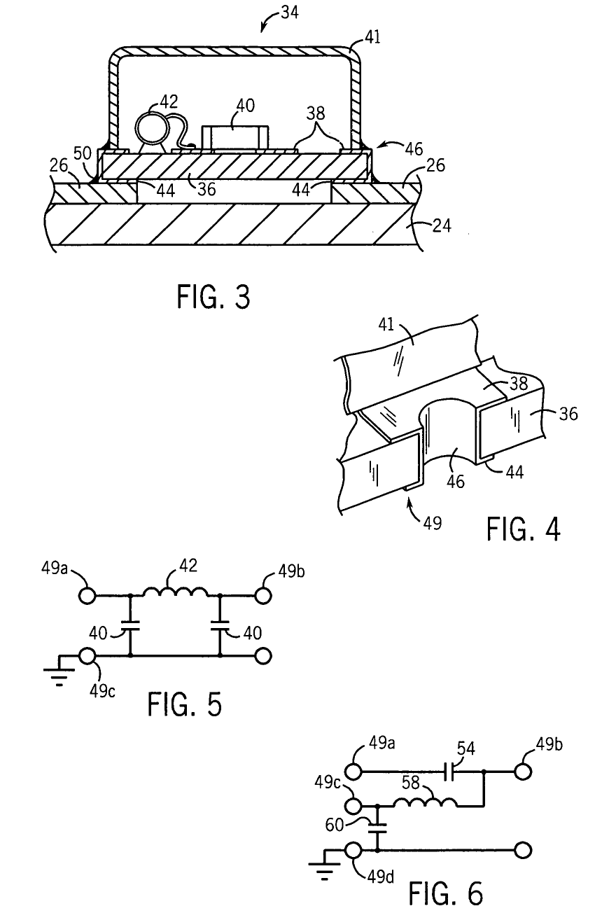

Referring now to FIG. 3, each of the modules 34 may be constructed on a non-magnetic carrier 36 being, for example, standard epoxy-glass printed circuit board material. The carrier's upper surface may include traces 38, for example, standard tinned copper foil traces as is understood in the printed circuit board art. Discrete components may be attached by soldering to the traces 38. These components may include chip capacitor 40 and air core inductor 42, the latter which may consist of turns of copper wire wrapped around a form having essentially the same magnetic characteristics as air. In particular, it is desirable not to use ferrite wound inductors 42 which have magnetic properties which may make them affected by the magnetic field of the polarizing magnet 12 of FIG. 1. Other components, not shown, may include diodes.

A non-magnetic housing 41 being a five-sided box, may be installed over the components 40, 42 and the traces 38 to seal the components 40 and 42 in a controlled environment between the housing 41 and the carrier 36. In this way, the components 40, 42 and the traces 38 are protected from environmental contamination and/or damage for or after assembly to the coil 20.

Referring now to FIG. 4, traces 38 on the top of the carrier 36 may communicate with conductive bottom pads 44 on the bottom of the carrier 36 removed from the components 40 and 42 by means of plate-through holes 46 well understood in the art. In a preferred embodiment, the carrier 36 is fabricated with many identical circuit patterns of traces 38 on a single sheet with rows of plate-through holes. The single sheet is then separated into multiple carriers along diameters of the plate-through holes 46, half of which are shared by adjacent modules 34.

Referring again to FIG. 3, the bottom pads 44 may communicate directly with the antenna conductors 26 on the insulating support 24 and the modules 34 may be attached to the antenna conductors 26 by fillets of solder 50 between the antenna conductors 25 and the bottom pads 44 and plate-through holes 46.

Prior to the installation of the non-magnetic housing 41, the devices may be tuned by adjusting their component values according to well-known techniques, including the selection of precise components, the use of tunable elements, physical alteration of the elements by trimming and/or by a culling process.

Referring now to FIG. 5, the phase shift modules 34 of FIG. 2, for example, may use a single inductor 42 extending between input and output terminals 49a and 49b on the module 34. Two capacitors 40 may extend from each side of the inductor 42 to a ground terminal 49c. While only three distinct electrical terminals created by plate-through holes 46 are required, as a practical matter multiple bottom pads 44 are dedicated to given signals particularly to ground. The bottom pad 44 for ground may be extended to a ground plane over the bottom of the carrier 36.

In tuning the circuit of FIG. 5, it is necessary that the capacitors 40 and inductor 42 be of the correct ratio so as to provide the desired degree of phase shifting as described above. Further capacitors 40 and inductor 42 must provide for the desired input impedance measured between terminal 49a and ground and the desired output impedance between terminals 49b and ground. Typically the input impedance will be, for example, 50 ohms and the output impedance 50 ohms at the operating frequency of the MRI machine being typically 12.7, 43, 63.8 and 127 MHz depending of the field strength of the MRI magnet.

As shown in FIG. 6, the modules 34 may be used with a variety of other circuits that may form building blocks for local coils 20. For example, in one such alternative circuit, a biasing T-junction (bias T network) is formed such as may be used for activating switching diodes incorporated into the local coil 20 for decoupling as is understood in the art. In this case, a DC blocking capacitor 54 is connected in series between an input terminal 49a and output terminal 49b and a bias current attached to terminal 49c which communicates through an inductor 58 to the output terminal 49b. The terminal 49c may also include a noise shunting capacitor 60 between terminal 49c and ground terminal 49d.

Other circuits may also be incorporated into these modules 34 including, for example, quadrature divider/combiner circuits which take two input circuits, phase shift one by 90 degrees and add them together at output terminals or analogously take a single signal and producing a 90 degree phase shifted signal and an unshifted signal at two sets of terminals. The modular construction of the present invention may also be useful for radio frequency switch circuits incorporating, for example, diodes that may be biased on by a biasing current, to conduct a radio frequency signal. Further, the present invention may be used with isolation circuits which operate to detect certain threshold voltages using diodes or the like incident to a radio frequency excitation signal to de-tune the local coil 20. An example isolation circuit is found in U.S. patent app. 10/303,586 filed Nov. 22, 2002 assigned to the assignee of the present invention and hereby incorporated by reference. The present invention may also be used for matching networks used to match circuits of different characteristic impedances as is understood in the art.

It is specifically intended that the present invention not be limited to the embodiments and illustrations contained herein, but include modified forms of those embodiments including portions of the embodiments and combinations of elements of different embodiments as come within the scope of the following claims.

We claim:

1. A method of manufacturing local coils for use in magnetic resonance imaging systems comprising the steps of:
a) assembling a plurality of multi-component circuits, each on a substantially non-magnetic carrier having exposed terminals communicating with the multi-component circuits;
b) pre-characterizing the electrical parameters of the multi-component circuits to conform to defined electrical parameters;
c) assembling an antenna structure of the local coil using antenna conductors supported on at least one insulating support; and
d) attaching the terminals of at least one of the carriers containing one of the multi-component circuits to the conductors to the antenna structure of the local coil.

2. The method of manufacturing recited in claim 1 wherein the circuits are constructed of substantially non-magnetic components.

3. The method of manufacturing recited in claim 1 wherein the components include at least one non magnetic core inductor.

4. The method of manufacturing recited in claim 1 wherein the pre-characterization includes a step of tuning adjustable components in the multi-component circuits.

5. The method of manufacturing recited in claim 1 wherein the pre-characterization includes the step of testing the multi-component circuits for conformation with the defined electrical parameters.

6. The method of manufacturing recited in claim 1 wherein the electrical parameters are input impedance and output impedance at a given operating frequency.

7. The method of manufacturing recited in claim 1 wherein the multi-component circuits are selected from the group consisting of: a phase shift network, a quadrature divider/combiner network, a bias T network, a radio frequency switch network; and an isolation network and a matching network.

8. The method of manufacturing recited in claim 1 wherein the multi-component circuits are phase shift networks and step (a) includes the manufacture of a plurality of phase shift circuits of different standard values of phase shift and wherein step (d) includes the step of connecting at least two of the phase shift circuits in series to obtain a desired phase shift being a sum of standard values.

9. The method of manufacturing recited in claim 1 wherein the carrier is a printed circuit board having an insulating substrate and copper traces.

10. The method of manufacturing recited in claim 9 wherein the terminals are provided by plate-through holes connecting to pads at the bottom of the carrier.

11. The method of manufacturing recited in claim 1 including a non-magnetic housing for covering the multi-component circuit.

12. A pre-manufactured circuitry module for a local coil for magnetic resonance imaging comprising:
a substantially non-magnetic circuit substrate receiving one or more substantially non-magnetic components to create a multi-component circuit selected from the group consisting of a phase shift network, a quadrature divider/combiner network, a bias T network, a radio frequency switch, an isolation network and a matching network, the multi-component circuit being pre-characterized to conform with defined electrical parameters;
a non-magnetic housing covering the multi-component circuit on the substrate; and
a set of non-magnetic terminals communicating between points on the multi-component circuit and areas exposed outside of the housing for attachment to conductors of the local coil.

13. The pre-manufactured circuitry module recited in claim 11 wherein the non-magnetic components include at least one non-magnetic core inductor.

14. The pre-manufactured circuitry module recited in claim 11 wherein the housing is hermetically sealed about the multi-component circuit.

15. The pre-manufactured circuitry module recited in claim 11 wherein the multi-component circuit is a phase shift network having one of a set of predefined standard values.

16. The method of manufacturing recited in claim 14 wherein the standard values provide in combination of no greater than three modules, no less than 80 degrees of phase shift in one-degree increments.

17. The method of manufacturing recited in claim 12 wherein the multi-component circuit is frequency sensitive and tuned to a center frequency of a magnetic resonance machine.

18. The method of manufacturing recited in claim 17 wherein the frequency of the magnetic resonance machine is selected from the group consisting of 12.7, 43, 63.8 and 127 MHz.

19. A method of tuning a local MRI coil having an antenna portion and a signal lead connecting the antenna portion to an amplifier comprising the steps of:
a) selecting from a set of pre-manufactured and pre-tuned phase shifting modules having different denominations, a combination of phase shifting modules providing a given phase shift; and
b) connecting the selected phase shifting modules in series with each other and the signal lead to provide a total phase shift between the antenna portion and the amplifier of an odd multiple of ninety degrees.
